(19) United States
(12) Patent Application Publication
(10) Pub. No.: US 2011/0100064 A1
(43) Pub. Date: May 5, 2011

(54) METHOD AND APPARATUS FOR MANUFACTURING AN OPTICAL FIBER CORE ROD

(75) Inventors: Arnab Sarkar, West Hills, CA (US); Bedros Orchanian, North Hills, CA (US); Heikki Ihalainen, Espoo (FI)

(73) Assignee: Nextrom Holling, S. A., Morges (CH)

(21) Appl. No.: 11/722,691

(22) PCT Filed: Dec. 22, 2005
(86) PCT No.: PCT/US2005/047075

§ 371 Date: Mar. 28, 2008

Related U.S. Application Data
(60) Provisional application No. 60/638,880, filed on Dec. 23, 2004.

(51) Int. Cl. C03B 37/012

(52) U.S. Cl. 65/428; 65/508

(57) ABSTRACT

A multi-functional method and apparatus are disclosed for producing a low hydroxyl ion-containing core rod from a tube suitable for the production of low-water optical fibers. The method and apparatus combine the use of process steps of (1) hermetically sealing a tubular quartz handle of a tubular porous core preform to a tube used to feed the porous preform into a sintering furnace, (2) dehydration and sintering, and (3) elongation of the sintered preform under vacuum, all without exposing the preform's central aperture surface to ambient atmosphere.

### BACKGROUND OF THE INVENTION

1. Field of the Invention

This invention relates generally to the manufacture of optical fiber preforms and, more particularly, to the manufacture of optical fiber core rods using a flame hydrolysis, or outside vapor deposition (OVD), process.

2. Description of the Prior Art

The basic flame hydrolysis process is described in U.S. Pat. No. 2,272,342, which issued to Hyde in 1942. The OVD process for producing porous glass preforms is described in detail in chapter 2 of a book entitled “Optical Communications, Volume 1, Fiber Fabrication,” edited by Tingye Li (1985). In the OVD process, vapors of glass-forming materials are fed through a water-generating flame, which reacts with the vapors to form small particles of glass, called soot, and is collected on a high-purity ceramic mandrel to form a porous cylindrical body. After deposition is completed, the mandrel is removed and the porous tubular body is dehydrated and sintered to a dense glass tube, after which the tube is elongated under vacuum to form a cylindrical core rod. Additional clad glass is added to the core rod by multiple processes to complete manufacture of optical fiber preforms, which then can be drawn into fibers suitable for use optical communications.

Very low water content optical fibers have been produced since the early 1980s and have been reported in “Electronic Letters,” 16, 699-700 (1980). However, it has been particularly difficult to use the OVD process to produce core rods, preforms, and optical fibers having very low hydroxyl ion (OH) content.

The OVD process was first described in U.S. Pat. No. 3,737,292 and more recently in U.S. Pat. Nos. 4,251,251; 4,298,365; 4,413,882; 4,486,212; 4,453,961; 4,515,612; 4,578,097; 4,583,997; 4,664,690; 4,684,383; 4,734,117; 4,784,465; 5,397,372; 5,692,087. Most recently, U.S. Pat. No. 6,477,305 B1 to Berkey et al., issued Nov. 5, 2002, (the Berkey '305 patent), appears to be the first patent reporting the production of low-water OVD single-mode optical fibers.

In the basic OVD process, the core and part of the cladding material were first deposited onto a removable, tapered ceramic mandrel, after which the mandrel was removed and the deposited porous soot body was dehydrated and sintered into a tubular core preform. In a subsequent step, the two ends of the tubular preform were sealed under vacuum, and the preform then was elongated to form core rods for further processing into optical fibers. The OH content of these OVD fibers was higher than is now required for commercial viability. This high OH content occurred primarily because of difficulties preventing re-hydration of the inner surface of the dehydrated and sintered core preform prior to sealing its two ends.

The Berkey '305 patent disclosed an improvement to this basic OVD process, in which the process steps of dehydration and sintering were combined with the process step of sealing the core preform's two ends under vacuum inside the sintering environment, without exposing the inner surface of the sintered tubular preform to atmospheric air.

Another improvement to the basic OVD process was disclosed in U.S. Patent Application Publication No. US 2004/0123630 A1, published in the name of Arnab Sarkar on Jul. 1, 2004. The publication teaches a method of elongating a sintered OVD preform to form a core rod, wherein one end of the preform is closed off and the preform's central aperture held under vacuum by attaching the preform's other end to a vacuum pump. This method eliminates the need to seal both ends of the preform, while the central aperture is under vacuum, and thus reduces the number of required process steps.

Those skilled in the art will appreciate that sealing the two ends of the preform inside or just above a sintering furnace, as taught is the Berkey patent, is complex and fails to produce fibers having as low an OH content as those produced by a vapor axial deposition (VAD) process, which yields a preform lacking the central aperture and which therefore need not address the problem of re-hydration of the inner surface. This is evident from the attenuation spectrum shown in FIG. 10 of the Berkey patent, where a distinct absorption peak is visible at a wavelength of 1380 nm. In contrast, such absorption peaks are not detectable in state-of-the-art VAD fibers.

It should therefore be appreciated that a need remains for an improved method and apparatus for improving the OVD process for making optical fiber preforms having low OH content, while avoiding the undue complexity of prior systems. The present invention fulfills this need.

### SUMMARY OF THE INVENTION

The present invention resides in a method and apparatus for manufacturing an optical fiber core rod having low OH content, while avoiding the undue complexity of prior systems. More particularly, the method includes steps of (1) providing a cylindrical silica glass preform having a central aperture extending along its length; (2) closing one end of the preform's central aperture, e.g., using a plug; (3) sintering the silica glass preform while directing sintering gases through the preform's central aperture; and (4) elongating the sintered silica glass preform while drawing a vacuum in the preform's central aperture, to yield a dense core rod suitable for use in making optical fibers.

In other, more detailed features of the invention, the method further includes a step of attaching a glass tube to a tubular handle secured at one end of the preform. The tube is used to direct sintering gases to the preform's central aperture during the step of sintering, and it is used to facilitate drawing a vacuum from the preform's central aperture during the step of elongating. The glass tube preferably is attached to the handle by a process of heat-sealing.

In another more detailed feature of the invention, the steps of closing and attaching are performed at a loading/unloading station; the step of sintering is performed at a sintering station; and the step of elongating is performed at a elongation station. In addition, the method further includes steps of moving the silica glass preform between the loading/unloading station and the sintering station, and between the sintering station and the elongation station, without exposing the preform's central aperture to the ambient atmosphere.

In other more detailed features of the invention, the glass tube is supported by a feed-through chuck mounted on a horizontal slide, and the horizontal slide, in turn, is mounted on a pair of vertical slides. Further, the steps of moving the silica glass preform between the loading/unloading station and the sintering station, and between the sintering station and the elongation station, are performed by moving the feed-through chuck on the horizontal slide and by moving the horizontal slide on the pair of vertical slides.

In yet another more detailed feature of the invention, the method further includes a step of removing the handle and an adjacent section of the glass tube following the step of elongating, to leave a remaining section of the glass tube suitable for use with another silica glass preform. This step of removing is performed at the loading/unloading station, and the method further includes a step of moving the silica glass preform between the elongation station and the loading/unloading station, without exposing the preform to the ambient atmosphere.

In other features of the invention, the method is carried out using a valve assembly that connects the glass tube with a source of sintering gases and with a source of vacuum. The step of sintering includes configuring the valve assembly so that sintering gases are directed through the preform's central aperture, and the step of elongating includes configuring the valve assembly so that a vacuum is drawn from the preform's central aperture.

In a separate and independent feature of the invention, the apparatus for making the optical fiber core rods 11 includes (1) a loading/unloading unit for use in attaching a glass tube to one end of a cylindrical silica glass preform of a kind that has a central aperture extending along its length, wherein the glass tube is connected through a valve assembly to a source of sintering gases and to a source of vacuum; (2) a plurality of sintering units, each configured to receive a cylindrical silica glass preform and attached glass tube, for dehydration and sintering of the preform, to yield a sintered preform; (3) an elongation unit configured to receive a sintered preform from any one of the plurality of sintering units, for elongating the sintered preform into a dense core rod suitable for use in making optical fibers; and (4) a frame assembly for transporting the cylindrical silica glass preform and attached glass tube from the loading/unloading unit to one of the plurality of sintering units, for dehydration and sintering, and, in turn, for transporting the sintered preform from the sintering unit to the elongation unit, for elongating into a dense core rod suitable for use in making optical fibers.

Other features and advantages of the invention should become apparent from the following description of the preferred embodiment, taken in conjunction with the accompanying drawings, which illustrate, by way of example, the principles of the invention.

### BRIEF DESCRIPTION OF THE DRAWINGS

FIG. 1 is a schematic cross-sectional view of a three-stage apparatus in accordance with the invention, for sintering and elongating an OVD core preform, while isolating the surface of the sintered preform's central aperture from ambient conditions.

FIG. 2 is a cross-sectional view of an as-deposited OVD core preform, after a ceramic mandrel has been removed and the tip of the preform plugged with an insert.

FIG. 3 is a cross-sectional view of the handle of the OVD core preform being sealed to a cylindrical loading tube of a sintering system.

FIG. 4 is a cross-sectional view of the OVD core preform sealed to the loading tube and inserted into a sintering muffle, ready to be dehydrated and sintered.

FIG. 5 is a cross-sectional view of the sintered OVD core preform being elongated under vacuum, to form a cylindrical core rod.

FIG. 6 is a cross-sectional view of the sintered OVD core preform as the handle is being cut from the loading tube.

FIG. 7 is a schematic plan view of a balanced-capacity apparatus for mass production of cylindrical core rods, the apparatus being configured to include a single loading/unloading unit, a single elongation unit, and multiple sintering units.

### DESCRIPTION OF THE PREFERRED EMBODIMENTS AND METHODS

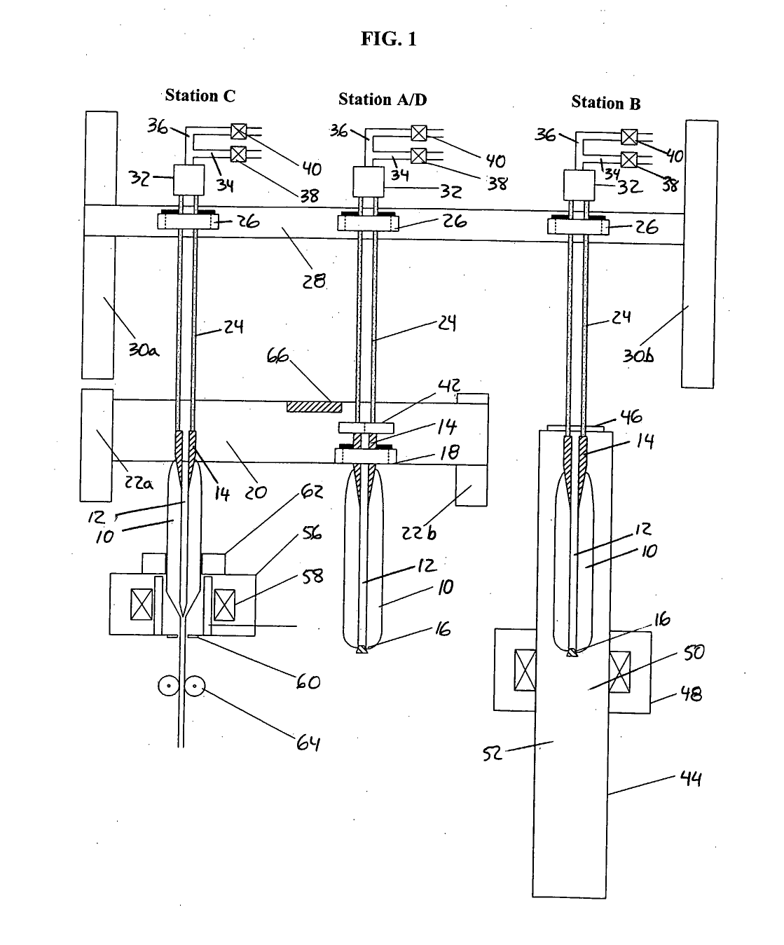

With reference now to the illustrative drawings, and particularly to FIG. 1, there is shown an apparatus for sintering and elongating a porous optical fiber core preform 10. The core preform has a generally cylindrical shape, with a central aperture 12, as customarily is produced using an outside vapor deposition (OVD) process. The apparatus has three stations, including a loading/unloading station A/D used for steps A and D of the process, a sintering station B for step B of the process, and an elongation station C for step C of the process. A frame for supporting various components of the apparatus has been omitted from the drawings, for clarity.

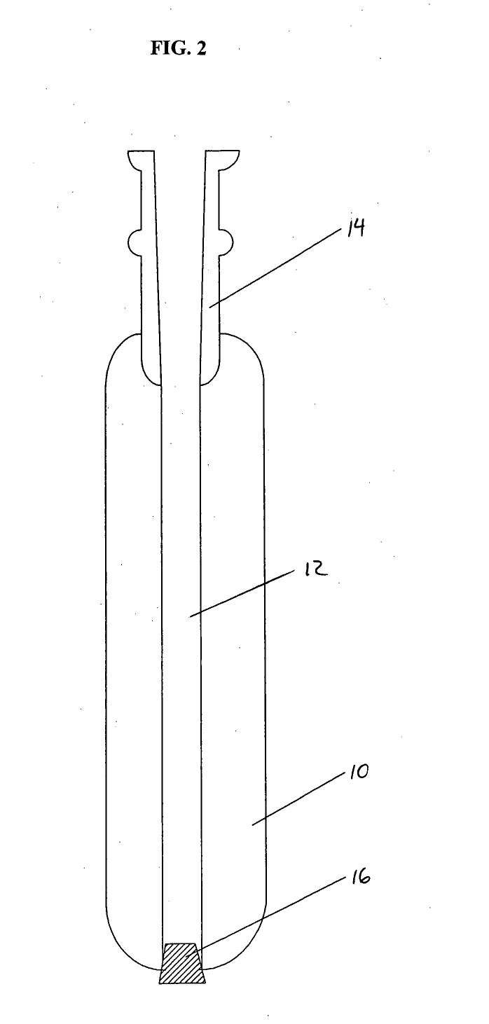

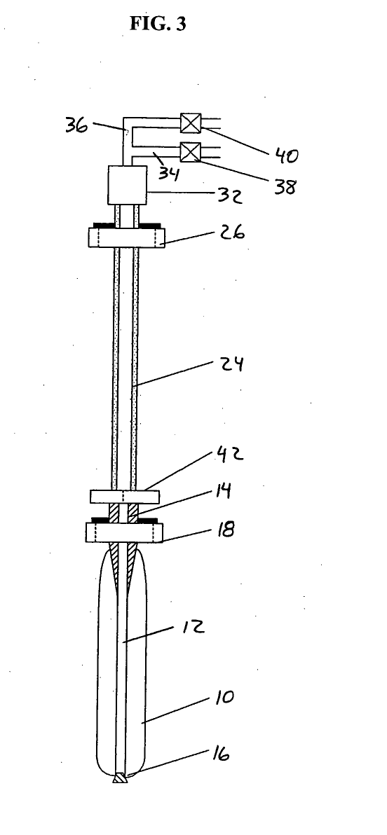

With additional reference now to FIGS. 2 and 3, the porous core preform 10 is shown to have a tubular quartz handle 14 projecting from its upper end. A mandrel on which soot was deposited to form the preform, has been removed from the preform, leaving the central aperture 12 extending along the preform's entire length. A suitable quartz plug 16 has been inserted into the aperture's lower end.

FIG. 3 depicts the condition of the preform assembly when it is located at the loading/unloading station A/D (FIG. 1). At this time, the handle 14 is held by a feed-through chuck 18, which is mounted on a horizontal crossbar 20 supported by two vertical slides 22a, 22b. A long, straight quartz tube 24 is positioned coaxially above the handle, where it is held in place by a feed-through chuck 26. This chuck is mounted on a horizontal slide 28, which is supported on two vertical slides 30a, 30b. The quartz tube has sufficient strength to carry the load of the core preform 10. The tube's upper end is held in a rotating union 32, also mounted on the horizontal slide 28, and the rotating union is connected to two conduits 34 and 36. The first conduit 34 and an associated valve 38 are used to supply dehydration and sintering gases into the quartz tube 24 from a source (not shown). The second conduit 36 and an associated valve 40 are connected to a vacuum pump (not shown).

While the core preform 10 is located in the loading/unloading station A/D for step A of the process, the horizontal slide 28 that mounts the quartz tube 24 is lowered on the vertical slides 30a, 30b until its lower end is positioned immediately adjacent to the upper end of the preform handle 14. At this time, the feed-through chucks 18 and 26 are rotated in synchronism. A split oxy-hydrogen ring burner 42, mounted on the horizontal crossbar 20, then is positioned around the interface between the quartz tube and the handle, in a vertical glass lathe configuration. The burner then is activated, to heat the tips of the two confronting components and, thereby, to heat-seal the tube to the handle. This process is similar to that used conventionally in a glass lathe.

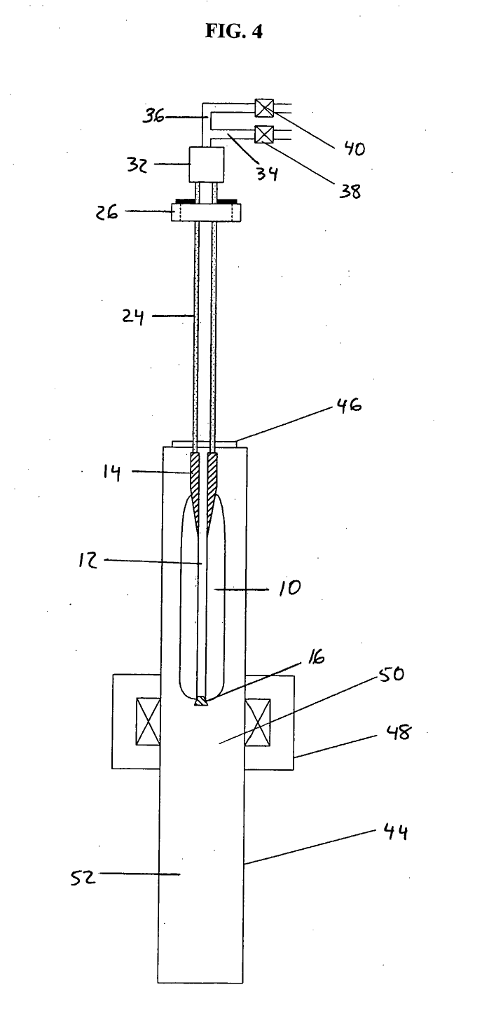

After the quartz tube 24 has been heat-sealed to the preform handle 14, the chuck 18 releases its retention of the handle, the ring burner 42 moves off axis, and the preform 10 is raised upward and indexed to Station B (FIG. 1). FIG. 4 depicts the preform and quartz tube at that station B, after they have been lowered into a quartz muffle 44, for sintering. A dynamic seal 46 mounted on a flange at the quartz muffle's upper end accommodates the preform and quartz tube, while isolating the muffle's interior space from the ambient atmosphere. Those skilled in the art will recognize that the sintering muffle cap must at all times remain above the quartz tube's lower end. The quartz muffle is located within a furnace 48, which includes a heating zone 50 that can be heated to a temperature suitable for dehydration and sintering of the preform 10.

After the sintering muffle 44 has been closed, the valve 38 is controlled to deliver appropriate sintering gases, including helium and chlorine, from a gas supply system (not shown) through the conduit 34, rotating union 32, quartz tube 24, and porous preform 10 into the muffle's interior space 52, to replace ambient air. The quartz muffle's outlet (not shown) is configured to facilitate regulation of that interior space. Dehydration and sintering of the preform 10 is then carried out in a conventional manner. Those skilled in the art will understand how to control the furnace and the gas flow in order to properly dehydrate and sinter the core preform, yielding a dry, dense glass preform. Those skilled in the art also will appreciate that sintering gases alternatively could be fed directly into the muffle's interior space via an inlet (not shown) located near the muffle's bottom end.

As the sintering cycle is completed, the bottom plug 16 seals the bottom end of the sintered preform's central aperture 12, and preform's upper end remains connected to the gas supply system through the rotating union 32. The valve 38 feeding the gases then is closed and valve 40 is opened, to maintain a controlled vacuum inside the central aperture.

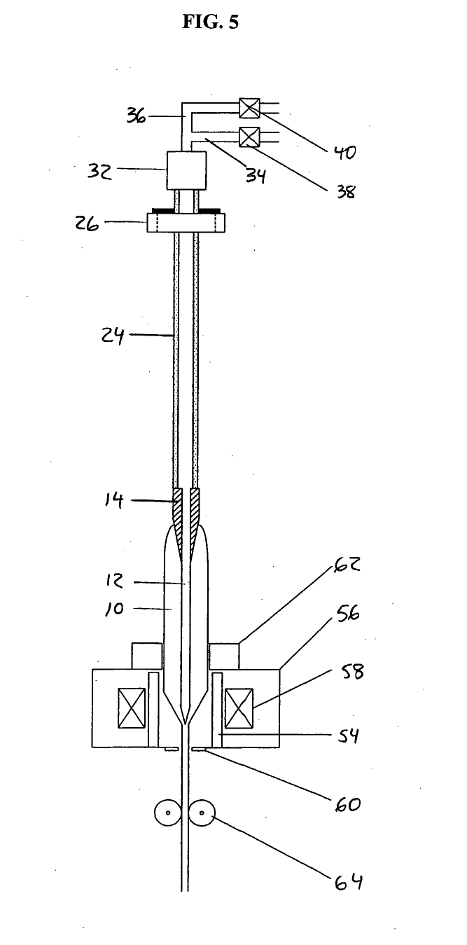

The sintered preform 10 and attached quartz tube 24 then are raised out of the sintering muffle 44 and indexed over to station C (FIG. 1), where the preform is elongated to form a dense core rod. At this time, the quartz tube remains connected to the rotating union 32, and the valve 40 remains opened, to connect the tube with the vacuum pump. At station C, and as shown in FIG. 5, the sintered preform 10 is lowered into a muffle 54 located within an elongation furnace 56. A heating element 58 encircles the muffle, and the furnace atmosphere is maintained neutral by irises 60 and 62 located at the furnace's respective lower and upper ends. An inert gas such as nitrogen, argon, or a nitrogen/argon mixture is directed to flow through the muffle.

Elongation and closing of the central aperture 12 of the sintered core preform 10 is carried out in a conventional manner. After the preform's temperature has reached a predetermined value, a pinch wheel assembly 64, or other suitable pulling mechanism, pinches glass from the preform's lower end. The force of elongation and the force of the vacuum automatically closes the tubular preform's central aperture. The resulting core rod is drawn through a diameter gauge (not shown), which allows elongation of the rod to a specified diameter. Substantially the entire preform is elongated, and the elongated core rods below the furnace are cut to size. The fixtures for accomplishing this function are omitted in FIG. 5.

At the end of the elongation step, the chuck 26 moves the assembly back to the loading/unloading station A/D, where the handle 14 is cut from the quartz loading tube 24. Those skilled in the art will recognize that, with sintering of each preform, a small length of the quartz tube, perhaps 1 to 5 cm, will be lost, and they further will recognize that, after a certain number of preforms, the quartz tube will need to be removed and replaced.

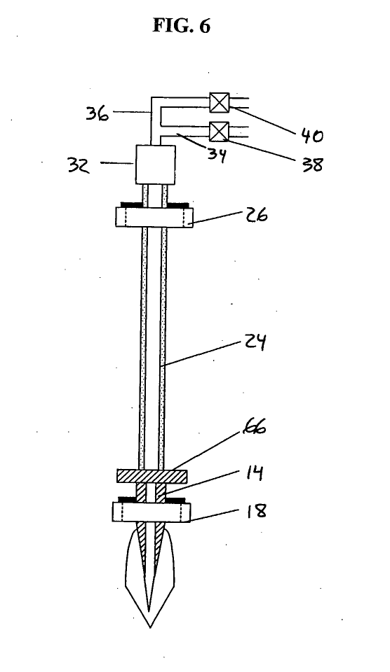

With reference now to FIG. 6, the preform 10 is depicted after most of its mass has been drawn into a core rod. At this time the preform's remaining mass, along with the attached handle 14 and quartz tube 24 are moved back to the loading/unloading station A/D (FIG. 1). The handle remains clamped by the feed-through chuck 18. At the loading/unloading station A/D, a cutting device 66 is positioned and controlled so as to cut the quartz tube at a location close to the handle. The cutting device is mounted on the horizontal crossbar 20. After the quartz tube has been cut, the chuck 18 can be opened and the preform handle 14 removed. A substantial portion of the quartz tube 24 remains, for use in processing one or more additional porous core preforms, in the same manner as the first preform was processed. Each such additional use results in the removal of about 1 to 5 cm from the quartz tube's length, so the tube eventually will need to be replaced with a new tube.

With reference again to FIG. 1, it will be observed that the horizontal crossbar 20 mounts the feed-through chuck 18, the split-ring burner 42, and the cutting device 66. The crossbar, in turn, is observed to be mounted on the vertical slides 22a, 22b. Horizontal slides for the split ring burner and the cutting device are not shown. FIG. 1 also depicts the second pair of vertical slides 30a, 30b, which support the horizontal slide 28 that mounts the feed-through chuck 26. The chuck 26 also has a second axis of horizontal movement capability, not shown in the drawing, to allow a precise alignment of the chuck's rotation axis to any reference point. The rotating union 32, which mounts the upper end of the quartz tube 24, is fitted via the conduits 34 and 36 to the respective valve 38 (connected to the gas supply system) and valve 40 (connected to the vacuum pump). The chuck 26 can slide along the horizontal slide 28, for accurate positioning at all three of the apparatus' stations A/D, B, and C. The elongation furnace 56 and the pinch wheel assembly 64 are fixed on a frame (not shown).

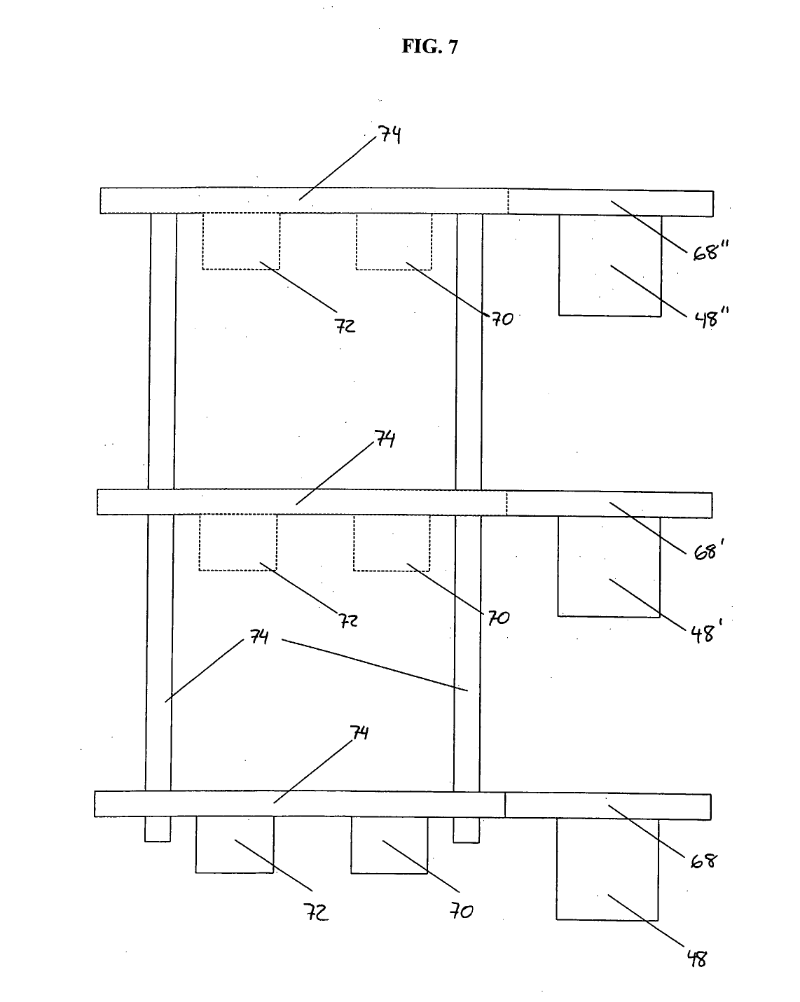

It will be appreciated that the cycle time of sintering is much longer than that of elongation. For this reason, it is preferable to associate multiple sintering units with each elongation unit. An apparatus for accomplishing this is shown in FIG. 7. Specifically, the apparatus includes three sintering furnaces 48, 48′, and 48″, each mounted on a separate frame 68, 68′, and 68″. Each such frame mounts a top assembly holding a separate chuck 26. A single loading/unloading unit 70 and a single elongation unit 72 are mounted on each frame, and these frames can move along rails 74 to position the units to work in conjunction with the sintering furnaces 48, 48′, or 48″. This configuration allows capacity balancing between the elongation and sintering units, thereby reducing the factory's capital outlay.

It should be appreciated from the foregoing description that the present invention provides an improved method and apparatus for producing dense glass core rods suitable for subsequent processing to form optical fibers. The method and apparatus yield rods having very low hydroxyl ion content. The apparatus moves a porous OVD core preform from a loading/unloading station to a sintering station, and in turn to an elongation station, and then back to the loading/unloading station, all while isolating the preform's central aperture from the ambient atmosphere.

The present invention has been disclosed in detail with reference only to the presently preferred embodiments. Those skilled in the art will appreciate that various modifications can be made without departing from the invention. Accordingly, the invention is to be defined only by the following claims.

We claim:

1. A method for making an optical fiber core rod comprising:
providing a cylindrical silica glass preform having a central aperture extending along its length;
closing one end of the preform's central aperture;
sintering the silica glass preform while directing sintering gases through the preform's central aperture; and
elongating the sintered silica glass preform while drawing a vacuum in the preform's central aperture, to yield a dense core rod suitable for use in making optical fibers.

2. A method as defined in claim 1, wherein:
the cylindrical silica glass preform has a handle attached to the end opposite the end that is, closed in the step of closing, wherein the handle includes a central aperture aligned with the preform's central aperture; and
the method further comprises attaching a glass tube to the handle, for use in directing sintering gases to the preform's central aperture during the step of sintering, and for use in drawing a vacuum from the preform's central aperture during the step of elongating.

3. A method as defined in claim 2, wherein attaching a glass tube to the handle includes heat-sealing the glass tube to the handle.

4. A method as defined in claim 2, wherein:
the steps of closing and attaching are performed at a loading/unloading station;
the step of sintering is performed at a sintering station;
the step of elongating is performed at a elongation station; and
the method further comprises steps of moving the silica glass preform between the loading/unloading station and the sintering station, and between the sintering station and the elongation station, without exposing the preform's central aperture to the ambient atmosphere.

5. A method as defined in claim 4, wherein:
the glass tube is supported by a feed-through chuck mounted on a horizontal slide;
the horizontal slide is mounted on a pair of vertical slides; and
the steps of moving the silica glass preform between the loading/unloading station and the sintering station, and between the sintering station and the elongation station, are performed by moving the feed-through chuck on the horizontal slide and by moving the horizontal slide on the pair of vertical slides.

6. A method as defined in claim 2, and further comprising removing the handle and an adjacent section of the glass tube following the step of elongating, to leave a remaining section of the glass tube suitable for use with another silica glass preform.

7. A method as defined in claim 6, wherein:
the step of elongating is performed at a elongation station;
the step of removing is performed at a loading/unloading station, separate from the elongation station; and
the method further comprises a step of moving the silica glass preform between the elongation station and the loading/unloading station.

8. A method as defined in claim 2, wherein:
a valve assembly connects the glass tube to a source of sintering gases and to a source of vacuum;
the step of sintering includes configuring the valve assembly so that sintering gases are directed through the preform's central aperture; and
the step of elongating includes configuring the valve assembly so that a vacuum is drawn from the preform's central aperture.

9. A method as defined in claim 1, wherein:
the step of sintering is performed at a sintering station;
the step of elongating is performed at a elongation station, separate from the sintering station; and
the method further comprises a step of moving the silica glass preform between the sintering station and the elongation station, without exposing the preform's central aperture to the ambient atmosphere.

10. A method as defined in claim 1, wherein the step of closing includes plugging the end of the preform's central aperture.

11. Apparatus for use in making optical fiber core rods, comprising:
a loading/unloading unit for use in attaching a glass tube to one end of a cylindrical silica glass preform of a kind that has a central aperture extending along its length, wherein the glass tube is connected through a valve assembly to a source of sintering gases and to a source of vacuum;
a plurality of sintering units, each configured to receive a cylindrical silica glass preform and attached glass tube, for dehydration and sintering of the preform, to yield a sintered preform;
an elongation unit configured to receive a sintered preform from any one of the plurality of sintering units, for elongating the sintered preform into a dense core rod suitable for use in making optical fibers; and
a frame assembly for transporting the cylindrical silica glass preform and attached glass tube from the loading/unloading unit to one of the plurality of sintering units, for dehydration and sintering, and, in turn, for transporting the sintered preform from the sintering unit to the elongation unit, for elongating into a dense core rod suitable for use in making optical fibers.

12. Apparatus as defined in 11, wherein the loading/unloading unit further comprises a device for removing the handle and an adjacent section of the glass tube after the sintered preform has been elongated into a dense core rod, to leave a remaining section of the glass tube suitable for use with another silica glass preform.
